(19) United States
(12) Patent Application Publication
(10) Pub. No.: US 2018/0320520 A1
(43) Pub. Date: Nov. 8, 2018

(54) APPARATUS, SYSTEMS AND METHODS FOR LUBRICATION OF FLUID DISPLACEMENT MACHINES

(71) Applicant: Bitzer US, Inc., Flowery Branch, GA (US)

(72) Inventors: Tom Brokaw, Flowery Branch, GA (US); Andrew Oxner, Reno, NV (US); Hans Wain, Truckee, CA (US)

(21) Appl. No.: 16/038,945

(22) Filed: Jul. 18, 2018

Related U.S. Application Data
(63) Continuation of application No. 14/628,247, filed on Feb. 21, 2015.
(60) Provisional application No. 61/943,301, filed on Feb. 21, 2014.

(51) Int. Cl. F01C 21/04; C10M 171/00; C09K 5/04; F01C 21/06; F01C 1/16; C10M 105/06; C10M 101/00

(52) U.S. Cl. CPC F01C 21/04; C10N 2240/30; C10N 2220/302; C10M 2203/1006; C10M 2203/065; C10M 171/008; C09K 5/045; F01C 21/06; F01C 1/16; C10M 105/06; C10M 101/00; C09K 5/04

(57) ABSTRACT

Apparatuses, systems, and methods are provided for the lubrication of fluid displacement machines, in particular positive displacement machines such as twin screw expanders utilized in organic Rankine cycle systems, comprising a working fluid mixed with a lubricant that is neither soluble nor miscible in the liquid phase of the working fluid.

### RELATED APPLICATIONS

This application claims domestic benefit of co-owned U.S. Nonprovisional application Ser. No. 14/628,247, filed Feb. 21, 2014 and entitled “Apparatus, Systems, and Methods for Lubrication of Fluid Displacement Machines”, which in turn claimed domestic benefit of U.S. Provisional Patent Application 61/943,301 entitled “Apparatuses, Systems, and Methods for Lubrication of Positive Displacement Machines”, filed Feb. 21, 2014. Both of said applications are incorporated herein by reference in its entireties for all useful purposes. In the event of inconsistency between anything stated in this specification and anything incorporated by reference in this specification, this specification shall govern.

### FIELD OF THE INVENTION

The present invention relates to apparatus, systems, and methods of lubricating fluid displacement machines, including positive displacement machines and, in particular, rotary screw expanders via the use of non-soluble, non-miscible, and/or undissolved lubricants mixed with the fluid upon which the machine acts or is acted upon by the machine.

### BACKGROUND

Machines which incorporate the flow of a fluid as a characteristic of their operation have a myriad of applications. Devices that fall within this definition are those machines which provide compression, expansion, pumping functionality and therefore encompass all manner of compressors, expanders, and pumps. Positive displacement machines are a particularly useful subset of such fluid-based machines. Configurations include linear displacement machines, reciprocating displacement machines, and rotating displacement machines. In some positive displacement machine applications, a motive force is applied to the machine and a fluid, in liquid or gaseous state, is propelled from the inlet of the machine to the outlet via displacement of the fluid by one or more movable surfaces of the machine. In other applications, the mass flow of the fluid or a physical process experienced by the fluid within the machine, such as expansion, imposes a force on one or more movable surfaces within the machine thereby causing the fluid to be propelled from the inlet to the outlet of the machine while generating a corresponding force that may be applied to perform work on an interconnected device or system. Specific lubrication requirements are dictated by the specific machine, application, and operating conditions, but machines that operate at higher pressures, at higher temperatures, with greater internal forces and external load requirements, and with components operating at greater linear or angular velocities generally impose more stringent lubrication requirements than do other machines.

Due to the forces and pressures involved, positive displacement machines are usually fabricated from hardened metal alloys for strength. Such devices require considerable lubrication to minimize friction which would otherwise generate considerable heat and wear to the machine, resulting in poor performance and premature failure. A wide variety of lubrication methods and systems exist for each the many configurations of positive displacement machines in use.

One particular class of positive displacement machine for which proper lubrication is essential is a rotational positive displacement device known as a plural screw positive displacement machine as described in U.S. Pat. No. 6,296,461. Also referred to as a “twin screw expander”, the device comprises a pair of helical-style intermeshing rotors mounted on parallel axes. Such devices may be employed in combination with a working fluid, such as a refrigerant, in systems where the refrigerant is caused to expand within the machine, thereby providing a rotational torque at the shaft output of the machine that may be coupled to perform work on another device or system, such as driving an electric generator to produce electric power. One class of systems based on this general principle are referred to as “organic Rankine cycle”, or ORC, systems, named for their use of the thermal Rankine process. A closed-loop flow of liquid working fluid, often but not necessarily a refrigerant, is heated to a gaseous or semi-gaseous state by an available and sufficient source of heat, allowed to expand in a suitable device such as a twin screw expander, cooled back into its liquid state, and then pumped and re-heated for subsequent expansion in a continuous process. In this manner, heat energy is converted into mechanical energy which may be used for any other useful purpose such as generating electric power via a generator or when coupled to one or more alternative or additional systems or devices.

Heat energy recovery systems employing the organic Rankine cycle (ORC) have been developed and employed to recapture heat from sources such as large combustion engines, boilers, and the like. One typical prior art ORC system for electric power generation from waste heat is depicted in FIG. 1. Heat exchanger 101 receives a flow of a heat exchange medium in a closed loop system heated by energy from a large internal combustion engine at port 106.

For example, this heat energy may be directly supplied from the combustion engine via the jacket water heated when cooling the combustion engine, or it may be coupled to the ORC system via an intermediate heat exchanger system installed proximate to the source of hot exhaust gas of one or more combustion engines. In either event, matter heated by the combustion engine or heat exchanger is pumped to port 106 or its dedicated equivalent. The heated matter flows through heat exchanger 101 and exits at port 107 after transferring a portion of its latent heat energy to the separate but thermally coupled closed loop ORC system which typically employs an organic refrigerant as a working fluid. Under pressure from the system pump 105, the heated working fluid, predominantly in a gaseous state, is applied to the input port of expander 102, which may be a turbomachine, a positive displacement machine of various configurations, including but not limited to a twin screw expander, or the like. Here, the heated and pressurized working fluid is allowed to expand within the machine and such expansion produces rotational kinetic energy that is operatively coupled to drive electrical generator 103 and produce electric power which then may be delivered to a local isolated power grid or the commercial power grid. The expanded working fluid at the output port of the expander, which typically is a mixture of liquid and gaseous working fluid, is then delivered to condenser subsystem 104 where it is cooled until it has returned to its fully liquid state. Condenser subsystem 104 may optionally include or be operatively coupled to a receiver tank, reservoir, or equivalent vessel for storing a quantity of cooled working fluid to insure a sufficient supply for system pump 105 at all times.

ORC systems are not limited to use with combustion engines and electric generators. Any sufficient source of heat may be applied to port 106 to vaporize the ORC working fluid, including but not limited to boilers, geothermally-heated water, fluid used to cool large solar arrays, gas compressors, or other industrial processes, or the like. Likewise, the rotational kinetic energy presented by the expander in the form of mechanical power may be applied for any useful purpose in addition to, or in lieu of, driving an electric power generator. Such purposes may include, but are not limited to, driving at least one of any of a pump, a combustion engine, a fan, a turbine, a compressor, or returning power to the source of input heat.

The condenser subsystem sometimes includes an array of air-cooled or liquid-cooled radiators or another system of equivalent heat-removal performance through which the working fluid is circulated until it reaches the desired temperature and state, at which point it is applied to the input of system pump 105. System pump 105 provides the motive force to pressurize the entire system and supply the liquid working fluid to heat exchanger 101, where it is once again heated by the energy supplied by the input heat and experiences at least a partial phase change to its gaseous state as the organic Rankine cycle process continues. The presence of working fluid throughout the closed loop system ensures that the process is continuous as long as sufficient heat energy is present at input port 106 to provide the requisite energy to heat the working fluid to the necessary temperature. See, for example, Langson U.S. Pat. No. 7,637,108 (“Power Compounder”) which is hereby incorporated herein by reference in its entirety and for all useful purposes.

The lubrication of positive displacement machines in ORC system has been traditionally accomplished by one of several means. A separate lubrication subsystem, comprising a pump, sump, interconnected tubing or conduits, and/or other associated equipment provides the necessary recovery of lubrication oil from various points in the system and returns a continuous flow of oil to the bearings and surfaces of the machine requiring lubrication. In these prior art systems, lubrication is not intentionally combined with the working fluid, although they may flow simultaneously in certain regions of the system as separate fluids. Such lubrication subsystems increase the number of components required to support the machine's proper operation, thereby increasing its cost and decreasing reliability since failure of the lubrication subsystem will render the machine inoperable.

Another method of positive displacement machine lubrication described as particularly well-suited for twin screw expanders in ORC systems is taught by Smith in U.S. Pat. No. 8,215,114. Here, a lubricant that is soluble or miscible in the liquid phase of the working fluid is directly mixed with said working fluid and flows, as a homogenous, uniform, and stable mixture, throughout the ORC system. It is taught by Smith that when heated, the liquid working fluid vaporizes (evaporates), leaving a higher concentration of lubricant in liquid form which is ostensibly sufficient to provide the necessary lubrication for the machine's operation. In particular, this patent teaches that when the mixture of working fluid and lubricant is injected at a bearing location associated with a rotary element of the expander, the heat generated by said bearing evaporates the liquid phase of the working fluid to leave sufficient concentrated lubricant in the bearing for adequate lubrication. This system and method provides the distinct advantage of not requiring a separate lubrication subsystem, thereby providing increased reliability and a lower manufacturing cost. However, this method and does not address situations where the bearing heat may be insufficient to evaporate the working fluid.

As lubricants do not exhibit thermal energy transfer properties similar to those of refrigerants, a mixture of working fluid and lubricant will impose some degradation in ORC performance when compared to that of a lubricant-free system. For that reason, a relatively low concentration (not more than 5% by weight) of lubricant is prescribed within the working fluid mixture so as not to excessively degrade the operational performance of the ORC system, which is largely dependent on the unique pressure and temperature vaporization characteristics of each particular working fluid. It is important to note that as a homogenous, miscible solution, this concentration of lubricant is uniformly present throughout the entire system at all times. At that concentration of lubricant, experimental observations have disclosed that in certain applications, physical degradation of twin screw expander bearings leading to failure occurs at bearing operating temperatures well below those required for vaporization of the working fluid as taught by Smith. Put another way, the bearings are seen to approach failure from lack of proper lubrication having never reached a temperature sufficient to vaporize the working fluid and provide a sufficient concentration of lubricant as taught by Smith. With certain machines and under certain operating conditions, the technology taught by Smith does not provide adequate lubrication of the machine.

Further, the use of a relatively small proportion of a soluble or miscible lubricant mixed with a fluid flowing through a fluid displacement machine degrades the lubricity of said lubricant. At a minimum, dilution of the lubricant by the fluid decreases its effectiveness. Additionally, by combining or bonding in some manner with another substance at the molecular level, at least a portion, and perhaps most if not all, of the beneficial properties of lubricants are lost. Solving this problem by increasing the proportional component of lubricant in a system heavily reliant on the thermal properties of a working fluid, such as an ORC system, risks degrading the system's ability to efficiently convert heat energy into mechanical or electrical power. It is therefore desirable to use the minimum proportional component of lubricant necessary to ensure proper lubrication. The trade-off between lubrication and system performance degradation represents a compromise not resolvable in the known art.

Therefore, the problem of properly lubricating fluid displacement machines, and in particular certain types of rotational positive displacement machines requiring highly reliable and effective means of lubrication, cannot be solved by present technology. Systems and methods which solve this problem would advance the present knowledge and be immediately useful in the art. The apparatus, systems, and methods disclosed herein provide technology for lubrication in fluid displacement machines of all types that does not require a separate lubrication subsystem and provides for full lubrication in systems that generate insufficient bearing heat to vaporize working fluid mixed with lubricant(s) that are soluble or miscible in the liquid phase of that working fluid as taught in the prior art.

### BRIEF SUMMARY OF SOME ASPECTS OF THE INVENTION

Apparatuses, systems, and methods are provided for the lubrication of fluid displacement machines, and in particular positive displacement machines such as twin screw expanders utilized in organic Rankine cycle (ORC) systems. Such lubrication systems and methods require neither a separate lubrication subsystem nor sufficient bearing heat for vaporization of working fluid mixed with a lubricant that is soluble or miscible in the liquid phase of the working fluid. In lieu of a soluble or miscible lubricant, this invention utilizes one or a combination of more than one wholly or substantially non-soluble or immiscible lubricant(s) mixed with the working fluid with special apparatus and methods to provide highly effective and reliable lubrication for a wide range of fluid displacement machines.

While the use of apparatuses, systems, and methods for non-soluble or immiscible lubrication of fluid displacement machines is particularly well-suited for use with positive displacement machines such as screw expanders, the disclosure herein is known to be useful with a wide variety of other machines as well. It should be understood that the use of the word “machine” herein is intended to apply to any and all machines, singularly or in combination with other machine(s), that may benefit from lubrication and through which a fluid passes, either as a driven media or as a media providing a driving force to the machine due to mass flow or any physical or state changes that may occur as the fluid passes through the machine. The addition of one or more non-soluble, immiscible lubricants to the fluid passing through any such machine to provide for its lubrication is within the scope of this invention and therefore envisioned by this disclosure.

In some embodiments, one or more lubricants that are not substantially soluble or miscible in the liquid phase of the working fluid are mixed in certain prescribed proportion with a working fluid for use in an ORC system. Such mixture of working fluid (“WF”) and one or more non-soluble, immiscible lubricant(s) (“NSIL”) comprises a non-homogenous colloidal WF/NSIL mixture of inherently unstable composition over time and that tends toward separation. During the normal operation of the system comprising the machine, the NSIL component of the colloidal WF/NSIL mixture is evenly dispersed at locations of interest in the system, At rest for a sufficient time, such colloidal mixture may achieve partial or nearly complete self-separation of the WF and NSIL components such that the NSIL component is no longer dispersed within the WF/NSIL mixture. Only traces of each component may by present in the separated strata of the other(s).

In some embodiments, the NSIL in the WF/NSIL mixture coats and lubricates the metallic surfaces of the machine and incidentally accumulates in the bearings and at other points requiring lubrication without the need for direct injection.

In some embodiments, the WF/NSIL mixture is directly supplied under positive pressure to one or more points in the system requiring lubrication with such lubrication provided by the NSIL component of the mixture. In particular, a lubrication line may be run from an extraction point in the system where a supply of the WF/NSIL mixture is available at a preferred temperature to communicate a portion of said mixture to the lubrication points. In some embodiments, cooled WF/NSIL mixture is extracted at the output of a system pump and operatively communicated to the housings of one or more bearings, the bearings directly, or other locations in the machine requiring lubrication. The NSIL present in the WF/NSIL mixture coats the bearings to provide exemplary lubrication as a result of the high affinity between the NSIL and metallic surfaces.

In some embodiments, WF/NSIL mixture is extracted from one or more other source points within the system and provided to the desired points of lubrication. If the pressure differential between the source of the WF/NSIL mixture and the lubrication input ports at the bearing housings and/or other points of lubrication is insufficient to provide the necessary flow, a supplemental lubrication pump may be employed to achieve reliable and controllable flow. In some ORC embodiments, expanded WF/NSIL mixture taken from the outlet of positive displacement machine 102 may be captured and immediately pumped back to the machine as necessary for lubrication. This WF/NSIL mixture may provide a source of lubrication closest to the operating temperature of the lubricated machine in circumstances when such temperature matching is optimal for the particular application. In a similar manner, WF/NSIL mixture may be obtained from any more desirable location within the system. However, it is generally preferred that the WF/NSIL mixture used for lubrication has a significant liquid component. Extracting wholly or substantially vaporized pre-expansion WF/NSIL mixture from the output of ORC heat exchanger 101, for example, may not be well-suited for lubrication of a twin screw expander in some ORC embodiments due to its high temperature and potential extraction difficulties at the point of greatest system enthalpy. However, different types of machines used in applications other than ORCs may have a myriad of preferable sources from which the lubricating WF/NSIL mixture may be extracted and no single solution will necessarily be optimal for every conceivable application.

In some embodiments, WF/NSIL mixture may be extracted from one or more positions within a fluid reservoir or receiver tank and supplied, via a supplemental lubrication pump, to the desired points of lubrication. Due to the tendency of the colloidal WF/NSIL mixture to separate as described elsewhere herein, the position within the reservoir or receiver tank at which a portion of the mixture is extracted for lubrication purposes will largely determine the relative proportion of working fluid to NSIL. Also as described in greater detail elsewhere herein, the colloidal mixture will tend to separate into layers, or strata, with indefinite boundaries but with varied compositions of the mixture that vary from comprising predominantly working fluid to predominantly NSIL. When extracted via a supplemental lubrication pump supplying sufficient motive force to extract the desired mixture and communicate it to the desired points of lubrication, the mixture me be extracted from any desired point within the tank. This affords the system designer the ability to select the precise location of extraction, and therefore the precise composition of WF/NSIL mixture, to achieve the desired lubrication results. In some embodiments, the point of extraction of the WF/NSIL mixture for lubrication purposes may be variable, via a moveable inlet port or similar means, and controlled either manually or via a microprocessor-based control system further comprising sensors capable of determining the composition of the WF/NSIL mixture and adjusting the position accordingly. In some embodiments, multiple extraction locations may be used, with the WF/NSIL mixture extracted from the location most favorable at any particular time for lubrication purposes. Similarly, this embodiment may comprise either manual control or be operated via a microprocessor-based control system further comprising sensors responsive to the composition of the WF/NSIL mixture. A combination of multiple extraction locations and movable inlet ports may be utilized in other embodiments.

In some embodiments, WF/NSIL mixture may be extracted by use of one or more skimmer(s) disposed at fluid reservoirs or receiver tanks. As discussed elsewhere, when the NSIL has a lower specific gravity than the fluid comprising the balance of the WF/NSIL mixture, separation via gravitational force provides NSIL-enriched fluid in the upper strata of the tank. Use of a skimmer to extract a portion of the WF/NSIL mixture from that uppermost strata would advantageously yield the portion of the mixture richest in lubricant for injection at the desired lubrication points.

In some embodiments, no agents are present within the colloidal WF/NSIL mixture to increase its compositional stability. In some embodiments, one or more agent(s), such as emulsifying agent(s), are present in the WF/NSIL mixture to increase the stability of the WF/NSIL mixture over time and therefore reduce its tendency to separate due to gravity or other internal or external stimuli.

In some embodiments, the WF/NSIL mixture varies in the relative proportion of non-soluble immiscible lubricant and working fluid as a function of position in the system. In other words, samples of the WF/NSIL mixture extracted at various points throughout the closed loop within which the WF/NSIL mixture circulates may contain non-identical concentrations of NSIL. Within segments of the closed-loop path experiencing reduced fluid movement, such as in certain portions of the system where condensed WF/NSIL mixture is allowed to accumulate, observed separation of the WF/NSIL mixture will be the greatest and relative proportions of each component are likely to vary greatly with relatively minor variations in sampling position. Within other segments of the system where fluid movement is the greatest or that are proximate to points where mechanical agitation of the WF/NSIL mixture is occurring, the relative proportion of each component of the WF/NSIL mixture will be more uniform as a function of minor variations in the sampling position.

In some embodiments, the relative proportions of non-soluble immiscible lubricant and working fluid within the WF/NSIL mixture as measured at a fixed location in the closed-loop path within which the mixture is circulating may vary as a function of time. In this embodiment, repeated measurements of NSIL concentration taken at a single location over a period of time during operation of the ORC system will vary as a function of time until a state of equilibrium has been achieved. This is particularly true during the initial start-up of an ORC system previously at rest for any appreciable period. As the colloidal WF/NSIL mixture naturally tends toward separation when said mixture is at rest and is not being agitated by one or more internal or external force(s), a re-started system may begin operation with a highly non-uniform distribution of working fluid and non-soluble immiscible lubricant. In some embodiments, a disproportionately large concentration of NSIL may collect at certain strata within the reservoir or receiver tank used to store cooled working fluid or elsewhere within an idle system. Similar to the disclosure above, depending upon the position from which fluid is drawn from said receiver tank and the presence or lack of agitation applied to the WF/NSIL mixture, the initial draw of WF/NSIL mixture from said receiver tank may be highly enriched with or essentially depleted of non-soluble immiscible lubricant since the NSIL component of the WF/NSIL mixture is not evenly dispersed at points in the system where such dispersion is important to system operation. As the system continues to operate, the distribution of NSIL throughout the system will begin to approach the normally-expected distribution of NSIL mixture at each point in the system, eventually reaching the proper concentration of NSIL under essentially steady-state operating conditions, at which point such concentration may still vary with position as described with respect to a previous embodiment. The state of operation in which the optimal dispersion of NSIL within the WF/NSIL mixture is achieved for steady-state operation may be referred to as lubrication equilibrium.

In some embodiments, a fluid bypass circuit comprising a valve may be employed around the machine to prevent its operation during period when the WF/NSIL mixture has not yet reached the state of lubrication equilibrium. During such periods, insufficient lubrication for the rotating surfaces and bearings of the machine would likely cause damage to or failure of the machine were it operate, so the initial flow of WF/NSIL is routed around, rather than through, the machine to prevent the machine's operation under conditions of unfavorable lubricity. Once the WF/NSIL mixture has reached proper lubrication equilibrium, the bypass valve may be closed, blocking the bypass flow and allowing the properly reconstituted WF/NSIL mixture to flow through the machine as it begins to operate. Control of the bypass valve may be accomplished either by manual methods or by a microprocessor-based control system used to monitor and control other aspects of the ORC system's operation.

In some embodiments, the localized homogeneity of the WF/NSIL mixture is relatively uniform at all points in the closed-loop circulation path between the outlet of a system pump and the outlet of the machine once the WF/NSIL mixture has attained lubrication equilibrium. Within this segment of the closed-loop ORC system, the circulating WF/NSIL mixture driven by positive pressure from the system pump is subject to an increase in enthalpy from the transfer of heat energy from a external source via one or more heat exchangers and subsequent expansion in the positive displacement machine. All of the WF/NSIL mixture present at the pump output appears directly at the output of the machine without any change in overall composition. With an active flow and no appreciable reservoirs of WF/NSIL mixture in this segment of the WF/NSIL mixture closed-loop circuit, there is nothing to add to or subtract from the original WF/NSIL mixture flow and therefore the overall concentration of NSIL in the WF/NSIL mixture flow must be uniform on the whole. These embodiments are particularly applicable in systems with predominantly liquid, minimally vaporized working fluid.

In some embodiments, the localized homogeneity of the WF/NSIL mixture is not uniform at all points in the closed-loop circulation path between the outlet of a system pump and the outlet of the machine once the WF/NSIL mixture has attained lubrication equilibrium. Even though there are no inlets or outlets for the mixture between these two points, the fact that the working fluid is at least partially vaporized by the heat supplied to the ORC system in these embodiments while the lubricant is not vaporized will result in a mixture comprised of liquid NSIL, vaporized working fluid, and possibly liquid (non-vaporized) working fluid. Under such conditions, the relative proportion of NSIL in any remaining non-vaporized liquid mixture will understandably higher than if the entire working fluid at that point were still in its liquid state, as it exists at the outlet of the system pump prior to vaporization in the heat exchanger.

In some embodiments, the total non-homogenous WF/NSIL mixture within the entire closed-loop ORC system, including lubricant present on internal surfaces of the system and pooled in higher concentration in fluid reservoirs or receiver tanks, comprises between 3% and 8% NSIL by mass. Preferably, the NSIL component is between 5% and 6% of the total WF/NSIL mixture by mass.

In some embodiments, the portion of non-homogenous WF/NSIL mixture flowing within the segment of the closed-loop circuit between the system pump output and the outlet of the machine under conditions of lubrication equilibrium is between 1% and 3% NSIL by mass. Preferably, this concentration is approximately 2% NSIL by mass. In some embodiments where a portion of the WF/NSIL mixture is extracted at the output of the system pump, the concentration of NSIL in the extracted portion of the mixture is the same as the concentration of NSIL within the segment of the closed-loop circuit between the system pump output and the outlet of the machine because both mixture portions are obtained from a common source.

In some embodiments, the non-homogenous WF/NSIL mixture is subjected to intentional agitation for the purpose of temporarily increasing the homogeneity of said mixture. In some embodiments, no intentional attempt is made to increase the homogeneity of the colloidal WF/NSIL mixture and the only agitation provided is that which is incidental to the normal operation of the ORC system.

In some embodiments, the ORC system includes one or more receivers, reservoirs, or vessels in which a portion of the WF/NSIL mixture is allowed to accumulate. These locations introduce the greatest likelihood that the WF/NSIL mixture will separate as is collects there, temporarily not subjected to incidental kinetic forces experienced during fluid circulation and thermal transfer. As the colloidal WF/NSIL mixture separates, a substantial portion of the total NSIL present in the system begins to collect at the uppermost layer of the non-circulating WF/NSIL mixture where it provides no lubrication to the system. It has been found that reducing the concentration of NSIL within the system does not prevent this accumulation but instead reduces the concentration of NSIL available in the WF/NSIL mixture for lubrication purposes, to the detriment of system operation.

In some embodiments, the ORC system does not include any receiver(s), reservoirs, or other vessels that permit WF/NSIL mixture to accumulate. In this embodiment, there is no accumulation of NSIL in the system at locations where it provides no lubricating function and the total amount of NSIL added to the system may be reduced without adversely affecting the concentration of NSIL where necessary for lubrication.

By way of example and not limitation, implementations of these and other embodiments of the invention may include one or more of the features described in detail below and elsewhere herein.

The machine requiring lubrication may be any fluid displacement machine suitable for use in the preferred system, whether for expansion, compression, pumping, or other purposes. The machine may impose a force on the fluid passing there through or the fluid may impose a force on the machine due to physical phenomena such as, but not limited to, expansion of the fluid, fluid mass flow through the machine under pressure, or in any other manner. In some embodiments, the machine is a positive displacement machine such as a twin screw expander particularly suitable for use in ORC heat recovery systems. In some embodiments, the machine may be any manner of rotational, reciprocating, linear, or non-linear machine suitable for use in the desired application which requires lubrication and which is also suitable for use with a working fluid in liquid, gaseous, or mixed liquid/gaseous phases.

The working fluid may be an organic refrigerant of the hydrofluorocarbon (HFC) class such as R-245fa, commercially known as Genetron® and manufactured by Honeywell. However, any organic refrigerant including but not limited to R-123, R-134A, R-22, and the like, as well as any other suitable hydrocarbons or other fluids, may be employed in other embodiments. The working fluid may also be water or any other substance suitable for the intended purpose of the machine and the system.

In some embodiments, the NSIL may comprise mineral oil or one or more of any other suitable liquid lubricant(s) that are neither soluble nor miscible in the liquid phase of the working fluid. Mineral oil is not soluble or miscible in HFC refrigerants such as R-245fa and its use therewith is compatible with this disclosure. One such type of mineral oil demonstrated to be sufficiently non-soluble and immiscible with R-245fa is manufactured by Nu-Calgon of St. Louis, Mo. and available in several viscosities (C-3s, C-4s, and C-5s) for different applications. However, mineral oil is known to be miscible with other refrigerants, including those comprising chlorinated compounds such as CFCs or HCFCs, so a lubricant other than mineral oil would be required for use with such refrigerants to comport with the teaching in this disclosure. In some embodiments, the NSIL may comprise synthetic replacements for mineral oil or other lubricants that are similarly neither soluble nor miscible in the liquid phase of the chosen working fluid. One such synthetic alternative for mineral oil is the family of alkylbenzene oil compounds manufactured by Nu-Calgon under the product name Zerol®. As with mineral oil, this product is known to be miscible with CFC and HCFC refrigerants but neither soluble nor miscible with HFC refrigerants such as R-245fa, rendering it suitable for use as an NSIL according to this disclosure with HFC refrigerants but not with CFC or HFC refrigerants. Again, the particular formulation of NSIL used in accordance with this disclosure is critically dependent upon the type and characteristics of the working fluid as well as the operating temperatures and pressures of the system since the miscibility of lubricants is partially dependent upon its temperature. In some embodiments, the NSIL may comprise a solid lubricant additive compound held in colloidal suspension in the working fluid in combination with, or in lieu of, one or more non-soluble immiscible or other liquid lubricant(s). Such solid lubricant additives may be of the type manufactured under the Acheson brand name and available from Henkel Corporation in Rocky Hill, Conn.

In some embodiments, the system further comprises one or more filters through which the WF/NSIL mixture extracted for injection at desired lubrication points, such as bearings, is passed to remove impurities, including but not limited to moisture and particulate contaminants, that may accumulate over periods of extended use. Such impurities may degrade the lubricity of the NSIL and generally be harmful to bearing life, particularly when applied to bearings under a continuous and considerable load. Filters suitable for these embodiments may include, but are not limited to, the OF series of filters offered by the Sporlan Division of the Parker Hannifin Corporation of Washington, Mo., the HF2P series of filters offered by McMaster-Carr of Santa Fe Springs, Calif., and the HF4RL series of filters offered by HYDAC USA of Glendale Heights, Ill.

Agitation of the WF/NSIL mixture increases the homogeneity of the WF/NSIL mixture by dispersing the NSIL component within the WF/NSIL mixture, Such agitation may be provided incidental to the process of circulating said mixture through the ORC system. Kinetic energy imparted to the WF/NSIL mixture in the ORC-related acts of pumping, circulating, heating, expanding, and condensing the WF/NSIL mixture provides a “mixing” action that works to counteract the mixture's natural tendency to separate. In some embodiments, this incidental agitation is sufficient to meet system requirements for achieving and maintaining lubrication equilibrium. In some embodiments, this incidental agitation is insufficient to meet system requirements for achieving and maintaining lubrication equilibrium. In some embodiments, additional agitation is required for proper operation. Such agitation may be provided by passive techniques, including but not limited to the placement of flow inlets and outlets in receiver tanks that allow gravity to act on the WF/NSIL mixture flow in a manner that disperses the NSIL within the WF/NSIL mixture, the use of fixed vanes in conduits and/or vessels through which the WF/NSIL mixture flows, rotating devices propelled by the motive force of the system pump acting on the WF/NSIL mixture, and the like. Active means of agitation, including but not limited to stirrers, circulators and circulation pumps, mixers, injection jets, and other mechanical or electromechanical devices or methods may also be used to maintain a suitable dispersion of NSIL within the colloidal WF/NSIL mixture at system points of interest.

The use of a mixture of working fluid and non-soluble immiscible lubricant(s) solves the problems not adequately served by the known art. It provides exemplary lubrication to a wide variety of fluid displacement machines, including those designed for continuous operation, without the need for dedicated lubrication systems comprising additional components and their attendant operational and maintenance requirements.

All know prior art specifically teaches away from the use of non-soluble immiscible lubricants in fluid displacement machine which do not also comprise a separate oil recovery and circulation system. The system and methods disclosed herein impose no requirement for, and do not benefit from, separation of the NSIL from the WF/NSIL mixture at any point. Once combined, the lubricant and working fluid components of the mixture coexist at all times and are never intentionally separated in the manner taught for prior art oil recovery systems. While the mixture components do tend toward self-separation due to their physical compositions, the system is designed to operate normally with both components mixed and agitated to a state of satisfactory lubricant dispersion. The earlier technology was not able to overcome several notable problems with NSIL lubrication schemes, including the accumulation of lubricant at undesired points in the system resulting in unacceptable degradation in system performance. The apparatus, systems, and methods taught herein have been experimentally and operationally verified to achieve the problem of providing desired lubrication without an oil recovery system or the previously-experienced reduction in system efficiency.

### BRIEF DESCRIPTION OF THE DRAWINGS

Without limiting the invention to the features and embodiments depicted, certain aspects this disclosure, including the preferred embodiment, are described in association with the appended figures in which;

FIG. 1 is a block diagram of a prior art ORC system used to convert heat energy into electric power;

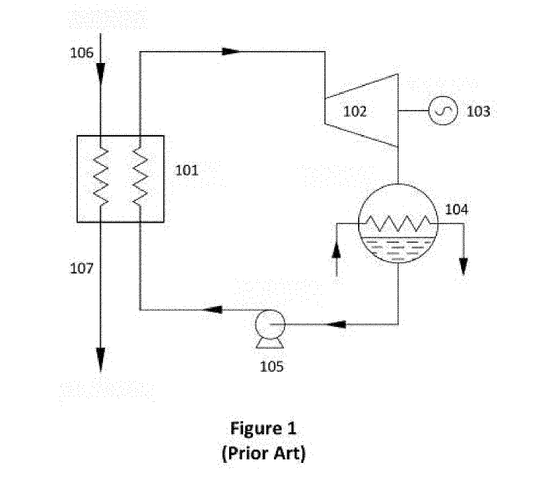

FIG. 2 is a block diagram of an ORC system used with this invention depicting a lubrication feed system from the outlet of the system pump to the positive displacement machine;

FIG. 3 is a graph that depicts the concentration of non-soluble immiscible lubricant present at the outlet of a system pump as a function of time after startup; and

FIG. 4 is cross sectional side view of a receiver tank in an ORC system depicting the stratification of the mixture of working fluid and non-soluble immiscible lubricant.

### DETAILED DESCRIPTION

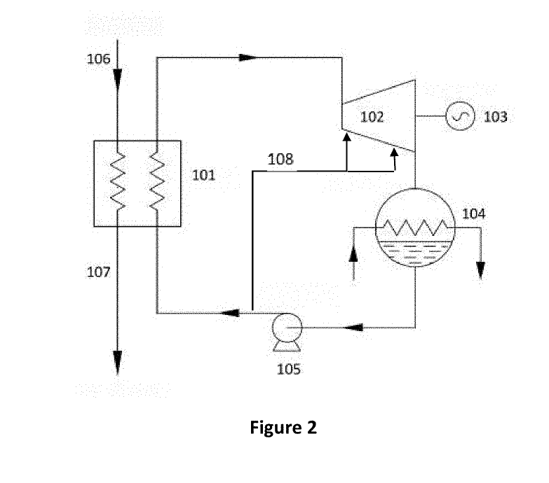

FIG. 2 depicts an ORC system configuration suitable for use with the present invention. Here, lubrication line 108 is operatively connected between the output of system pump 105 and one or more points requiring lubrication in positive displacement machine 102. In some embodiments, these points are bearing housings within which one or more ball, roller, sleeve, or other configuration of bearings are housed. The flow of WF/NSIL mixture under positive pressure from the system pump 105, which may be controlled by a microprocessor-directed variable frequency drive (“VFD”) system, provides a stream of lubricating mixture to the bearings and/or other lubrication points. While the WF/NSIL mixture may be extracted from any convenient or desired point in the system, the output of system pump 105 is a particularly advantageous point of extraction for several reasons. It is the point of greatest positive pressure of any WF/NSIL mixture location in the ORC system, as system pump 105 is the sole source of such motive pressure for the WF/NSIL mixture in the particular system depicted. No additional pressure-inducing components are required if a small portion of the positive pressure generated by system pump 105 is used to supply a stream of WF/NSIL mixture for lubrication purposes.

Another significant advantage of obtaining WF/NSIL mixture for lubrication purposes at the output of system pump 105 is that this point also presents the lowest temperature WF/NSIL mixture anywhere in the ORC system. The WF/NSIL mixture at this point has been fully condensed and will provide the maximum heat dissipation when applied to the bearings or other lubrication points at the machine. While the use of warmer mixture may be acceptable or even desired in some embodiments, the cooler lubrication source is often preferred.

Regardless of the preferred source of WF/NSIL mixture used for lubrication, the flow rate may be controlled by one or more valves or other flow control devices so as to achieve the desired flow rate. This is particularly useful when the WF/NSIL mixture is obtained at the output of system pump 105, as the speed of the VFD-controlled pump is dictated by the larger operational requirements of the ORC system and cannot be varied to accommodate lubrication concerns. In cases where a dedicated supplemental lubrication pump is employed for provide adequate pressure for the lubrication feed, the flow of WF/NSIL mixture to the bearings or other points of lubrication may be controlled in whole or in part by controlling the operation of said dedicated supplemental pump in place of, or in combination with, suitable valves or other flow control devices.

The choice of lubricant to be mixed with the chosen working fluid is critical. There are a wide variety of working fluids suitable for use in the many applications to which this disclosure applies. The essential characteristic of the WF/NSIL mixture of this invention is that the working fluid and the non-soluble immiscible lubricant form a colloidal mixture rather than a homogenous, uniform solution. By way of illustration and not limitation, examples will be provided using preferred ORC systems. The same principles apply to other applications when appropriately adjusted for their specific requirements. Some ORC systems utilize water, vaporized into steam by the input heat, as a working fluid. For those systems, a wide variety of oils and other lubricants not soluble in water may be appropriate for use, potentially including petroleum-based lubricants. Many ORC systems utilize refrigerants, including but not limited to organic refrigerants, in lieu of water as a working fluid. The complex chemical composition of refrigerants is an area of active development driven in large measure by concerns surrounding the potential effect of legacy refrigerants on the environment. As another non-limiting example, the refrigerant discussed above (R-245fa) is classified as a hydrofluorocarbon (HFC) compound and lacks the chlorine component of the earlier generation of chlorofluorocarbons (CFCs), such as R-12, as well as the later generation of hydrochlorofluorocarbon (HCFC) refrigerants, such as R-22, both now deprecated since being deemed environmentally undesirable. Due to their different compositions, certain lubricants soluble or miscible in chlorinated refrigerants are not similarly soluble or miscible in non-chlorinated refrigerants, including but not limited to HFCs such as R-245fa.

An essential element of this invention is the non-soluble immiscible character of the WF/NSIL mixture. It is not sufficient to identify a fluid and a lubricant independently of this requirement. Due to the differences in composition of both components, each must be carefully selected in full consideration of the characteristics of the other. In the embodiment described above, one such combination experimentally and operationally verified to produce the desired non-soluble immiscible WF/NSIL mixture consistent with this disclosure is the refrigerant R-245fa and mineral oil or its closely-related synthetic alternatives such as alkylbenzene oil. This example is illustrative of one preferred embodiment and is not limiting upon the scope of this invention in any way, as it is believed that numerous other combinations of fluids (refrigerants and non-refrigerants) and lubricants may be used to comprise an appropriate colloidal mixture for a wide variety of applications consistent with this disclosure.

Because the WF/NSIL mixture is colloidal in nature, it is by definition non-uniform at the microscopic level and for a certain sample range above that. Unlike soluble or miscible compositions where the components in a homogenous mixture may be difficult or even impossible to separate without elaborate processing, the colloidal WF/NSIL mixture is self-separating. Even with extreme agitation, visual inspection of the WF/NSIL mixture reveals the presence of NSIL droplets (as the discontinuous phase) distributed throughout the working fluid (as the continuous phase). The NSIL droplets constantly seek to combine with each other, forming larger droplets that collect on the upper layers of any accumulation of WF/NSIL mixture at rest as they are displaced in the mixture by the working fluid of greater specific gravity settling to the lower layers due to gravitational force.

With regard to any assessment of the composition of the colloidal WF/NSIL mixture, it must be understood that determination of the proportional composition of the colloidal WF/NSIL mixture requires a sample of appropriate size for the purpose at hand. By way of example and not limitation, a sample size of 5 mL or less may be optimal for the purpose of characterizing a WF/NSIL mixture at rest that has essentially separated into strata when the task at hand is to determine the boundaries of such strata as precisely as possible. When assessing the overall composition of a colloidal WF/NSIL mixture that is only slightly more agitated than in its fully separated state, a 5 mL sample taken at a particular location may be highly misleading due to the lack of uniformity in the WF/NSIL mixture. Instead, a sample between 100 and 500 mL, or greater, may be advisable. In circumstances involving a highly agitated and well-dispersed colloidal WF/NSIL mixture, a sample size of between 10 and 50 mL may suffice to accurately determine its proportional composition. All discussions herein regarding the proportional composition of a WF/NSIL mixture are predicated on the basis that such composition is based a suitable sample size for the state of dispersion of NSIL within the WF/NSIL mixture, as such state will vary greatly throughout the system as discussed below.

The time-dependent variation in the relative concentration of NSIL in the WF/NSIL mixture should understood to be a function of many characteristics of the materials and the system within which the WF/NSIL mixture circulates in a closed loop. Factors which affect the time-dependent concentration of NSIL in the WF/NSIL mixture include, but are not limited to, a) the time-dependent propensity for the WF/NSIL mixture to separate while at rest, b) the amount of time that has lapsed since the ORC system's last shutdown and/or the state of the WF/NSIL mixture at commencement of operation, c) the physical operating constants of the system, such as mass flow rate of the WF/NSIL mixture, the capacity of any WF/NSIL mixture receiver or storage tanks, temperature and pressure of the WF/NSIL mixture at any point, and the like, 4) the absence or presence of any mechanical or other agitation that would affect the time required for the WF/NSIL mixture to reach its optimum state of lubrication equilibrium, 5) sheer randomness in location and/or other factors under which the WF/NSIL mixture separates, and 6) any other factors that would enhance or retard the process of attaining an optimal WF/NSIL mixture. The tendency of the unstable colloidal WF/NSIL mixture to naturally separate on its own when the mixture is at rest and not subject to agitation (listed as factor (a) above) is a characteristic of the properties of the working fluid component(s) and non-soluble immiscible lubricant component(s) of the WF/NSIL mixture and is largely independent of the system in which the WF/NSIL mixture is utilized.

The degree of dispersion of NSIL in the WF/NSIL mixture is of interest only at certain points in the system. One such point is the location in the system where a portion of the mixture is extracted for application at desired points of lubrication. It important that the mixture obtained for direct injection lubrication contain the desired quantity of NSIL lubricant. Extracting lubricant-depleted mixture for lubrication purposes, particularly when done unintentionally, would jeopardize the operation of the machine. As described above, extracting a portion of the WF/NSIL mixture at the output of the system pump would be preferred in some embodiments. At this point in the system, having just been churned by the pump's impellers, the mixture would be relatively homogeneous and well-dispersed, and if the input flow to the system pump contained an appropriate concentration of lubricant, the portion extracted for lubrication purposes would likewise contain an appropriate concentration of NSIL evenly dispersed within the output flow of the system pump. In another embodiment, the mixture extracted for lubrication injection may be taken from a reservoir or receiver where the mixture has been allowed to rest relatively undisturbed for a period of time. Due to the self-separating nature of the colloidal mixture, the location of the extraction point within the reservoir or receiver tank will largely determine the concentration of lubricant in the extracted mixture. As described elsewhere herein, extracting fluid from the upper strata of separated mixture will yield a much higher concentration of lubricant than if the sample is extracted near the bottom of the tank. At certain points in the system, the relative concentration of lubricant in the WF/NSIL mixture is not critical to the operation of the system, although due to the closed-loop circulating nature of the system, the relative proportion of working fluid and lubricant(s) will generally be constant on the whole for a similar and appropriate sample size obtained between the source point and the exit point if a similar degree of agitation is maintained for the mixture.

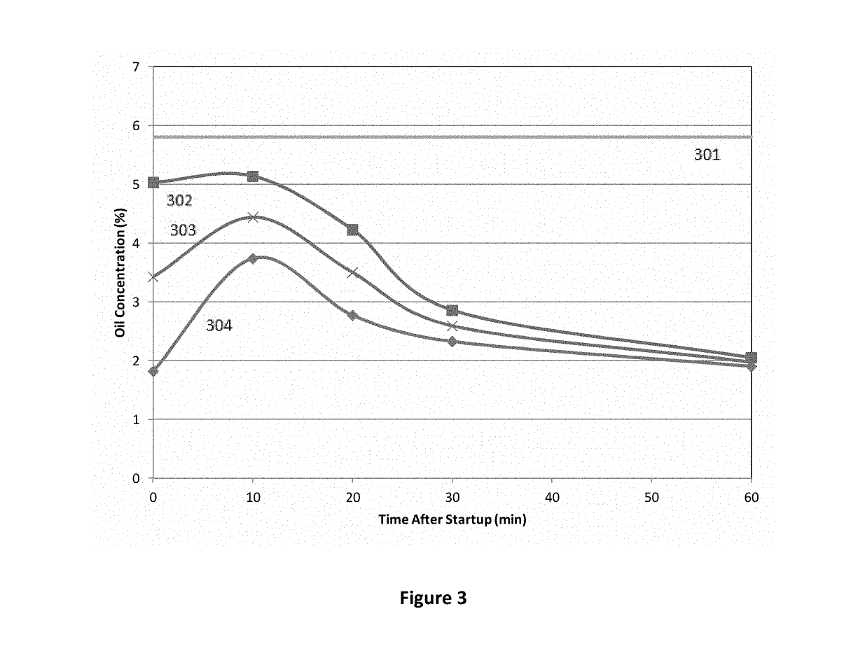

In FIG. 3, empirical test data related to the variation in NSIL concentration as a function of time after startup of an ORC system is depicted. In this series of measurements, the total WF/NSIL mixture contained in the closed-loop of an ORC system was 5.8% NSIL by mass (depicted by curve 301). For each trial, WF/NSIL mixture samples of sufficient quantity were collected at the output of system pump 105 in an ORC system configuration similar to that depicted in FIG. 2. The machine was started and the proportional composition of the WF/NSIL mixture was measured at the start, at 10 minute increments for the first 30 minutes of operation, and again after 60 minutes of operation. Following collection of the data, the ORC system was stopped and the WF/NSIL mixture in the closed-loop system was allowed to rest without movement or agitation until it was believed to have reached its naturally quiescent state.

Curve 302 represents the data associated with the iteration with the maximum observed concentration of NSIL at the start, curve 304 represents the same data for the iteration with the lowest observed concentration at the start, and curve 303 represents the average (mean) data for all test iterations performed. It can be seen that the starting values varied widely over a range of almost 3:1. This variation is attributable to the fact that the WF/NSIL mixture readily separates when the ORC system is stopped and the data provides insight that the separation of the WF/NSIL mixture within the closed-loop circuit has at some degree of randomness and therefore is not a highly repeatable or predictable phenomenon.

A particularly valuable conclusion that may be drawn from the data is that regardless of the starting concentration of NSIL in the WF/NSIL mixture, the measured concentration of NSIL in the WF/NSIL mixture was seen to converge on a highly repeatable value of approximately 2%. It is also important to observe the difference between this value and the overall NSIL concentration of 5.8% based on known and carefully measured quantities installed at the test commissioning of this particular system. It is also important to note that this 2% concentration of lubricant flowing within the active portion of the system is substantially less than the 5% taught by Smith in that prior art system.

The difference between the overall concentration of NSIL and the observed concentration at the output of system pump 105, which also represents the concentration at the output of positive displacement machine 102 due to the closed-loop circuit between those two points, is attributable to several factors. First, NSIL has extremely strong affinity to bond with metal surfaces in the ORC system, including but not limited to the surfaces and bearings of the positive displacement machine, the metallic inner surfaces of heat exchanger 101, and metallic inner surfaces of condenser subsystem 104, all of which are directly in contact with the WF/NSIL mixture flow. This affinity causes a thin film of NSIL to be deposited on these surfaces, providing lubrication on the case of the surfaces, bearings, and other lubrication points of the positive displacement machine. While no lubrication is specifically required for the inner metallic surfaces of the heat exchanger 101 and condenser subsystem 104, the deposition of NSIL on these surfaces was observed to have a negligible effect on their thermal properties and performance. At the overall ORC system concentration of 5.8% NSIL by mass, the comprehensive performance of the ORC system was only de-rated by approximately 2%, which includes both the effect of the oil deposition within the thermal subsystems and the addition of non-refrigerant NSIL to the refrigerant working fluid required for proper operation of the ORC system. This 2% degradation in system performance is notable in that it is far less than reported in the prior art for similar systems utilizing a mixture of working fluid and soluble or miscible lubricants.

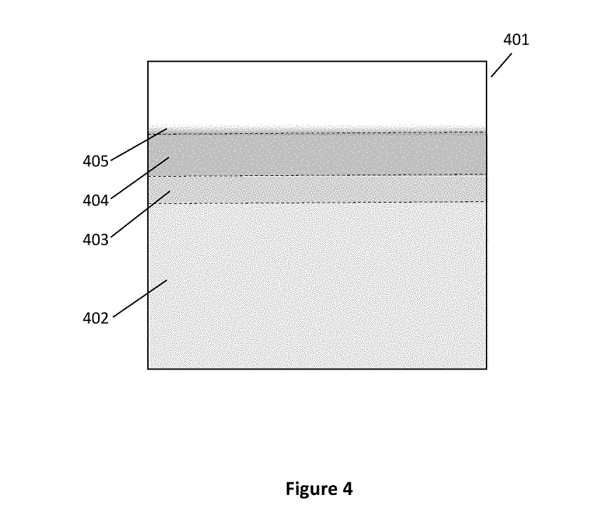

Additionally, the difference between the overall ORC system concentration of 5.8% NSIL by weight and the observed 2% concentration at the point of lubrication equilibrium is partially attributable to the accumulation of NSIL in the receiver tank associated with the condenser subsystem. FIG. 4 presents a representative depiction of the stratification of the components in the receiver tank 401 measured during ORC system operation at the point of lubrication equilibrium. While the boundaries between adjacent stratum are not clearly defined, the regions have distinct characteristics that provide valuable insight into the nature of this invention.

Stratum 402 is a faintly milky colloidal mixture comprising primarily organic refrigerant working fluid with a small quantity of suspended NSIL. This stratum extends upward approximately 9.5 inches from the bottom of the tank. Stratum 403 is a transition zone approximately 1 inch in depth and, although similarly milky in appearance, further comprises droplets of NSIL of increasing size and number toward its upper edge. Stratum 404, approximately 1.5 inches thick, is largely comprised of NSIL with random droplets of working fluid refrigerant. Stratum 405, approximately 0.5 inches high, is a region comprised of agitated working fluid and NSIL. Due to the agitation, the upper surface is irregular and subject to variation. Partially vaporized working fluid occupies the remaining volume between the upper surface of stratum 405 and the upper inside surface of receiver tank 401.

The demonstrated and observed affinity of NSIL for the surfaces, bearings, and other lubrication points in the machine represent a noticeable and significant improvement over the present use of lubricants that are soluble or miscible in the working fluid. Experimental observations reveal a much higher concentration of NSIL at the critical points in the system despite the absence of sufficient bearing temperatures necessary for proper lubrication in the prior art. Further, experimental testing has revealed that the use of NSIL in lieu of soluble or miscible lubricants as taught in the prior art results in decreased bearing wear over significant periods of use. In the case of NSIL, bearing temperature under operating conditions is irrelevant as it is no longer necessary to vaporize working fluid to provide adequate lubrication as taught in the prior art. The use of lubricants that are inherently insoluble and immiscible in the working fluid represents a clear departure from prior teaching in this field. It is believed that the present art relied upon a presumption that a mixture of working fluid and lubricant was best achieved through the use of lubricants that were either soluble or miscible in the liquid phase of the working fluid that would yield a stable, homogenous mixture of lubricant and working fluid. However, the use of NSIL as taught herein provides superior performance despite the fact that the WF/NSIL mixture can, by definition, never be completely homogenous and its instantaneous composition inherently stable in colloidal form.

The description of this invention is intended to be enabling and not limiting. It will be evident to those skilled in the art that numerous combinations of the embodiments described above may be implemented together as well as separately, and all such combinations constitute embodiments effectively described herein.

What is claimed is:

1. A system for lubricating a fluid displacement machine, the system comprising:
A. a fluid;
B. a fluid displacement machine comprising at least one fluid input and at least one fluid output;
C. at least one lubricant that is neither soluble or miscible with the fluid, said lubricant combined with the fluid to form a colloidal fluid mixture flowing through the machine from the at least one fluid input to the at least one fluid output;
D. at least one mixture extraction point at which a portion of the mixture is extracted for lubrication purposes; and
E. at least one desired point of lubrication in the machine in mixture receiving communication with the mixture extraction point.

2. The system of claim 1 wherein the system pressure at the at least one mixture extraction point is sufficiently higher than the system pressure at the at least one desired point of lubrication such that mixture flows from the at least one mixture extraction point to the at least one desired point of lubrication.

3. The system of claim 1 further comprising at least one lubricant filter disposed between the at least one mixture extraction point and the at least one desired point of lubrication.

4. The system of claim 1 wherein a lubrication pump is disposed between the at least one mixture extraction point and the at least one desired point of lubrication.

5. The system of claim 1 wherein the machine is a screw expander.

6. The system of claim 1 wherein the fluid comprises an HFC refrigerant and the lubricant comprises at least one of a mineral oil, an alkylbenzene oil, or a solid lubricant additive compound held in colloidal suspension.

7. The system of claim 6 wherein the HFC refrigerant comprises R-245fa refrigerant.

8. The system of claim 1 wherein agitation of the mixture is provided by the flow of said mixture through the system.

9. The system of claim 1 wherein agitation of the mixture is provided by at least one of any of fixed vanes, rotating devices, stirrers, circulators, circulation pumps, mixers, and injection jets.

10. The system of claim 1 further comprising a system pump in mixture receiving communication with the at least one fluid output and in mixture sending communication with the at least one fluid input, and wherein at least one mixture extraction point is in mixture receiving communication with the output of the system pump.

11. The system of claim 1 further comprising at least one mixture reservoir or receiver wherein the at least one mixture extraction point is in mixture receiving communication with at least one point in the at least one mixture reservoir or receiver.

12. A method of lubricating a fluid displacement machine comprising:
A. providing a fluid;
B. providing an apparatus comprising at least one machine which acts upon, or is acted upon by, the fluid as it passes through the machine;
B. providing at least one lubricant that is neither soluble or miscible with the fluid;
C. combining the fluid and the lubricant to form a colloidal fluid mixture;
D. circulating the mixture through the apparatus and the at least one machine; and
E. extracting a portion of the mixture and using it to lubricate at least one point in the machine.

13. The method of claim 12 wherein step (E) further comprises passing the extracted portion of the mixture through at least one lubricant filter.

14. The method of claim 12 wherein the fluid comprises an HFC refrigerant and the lubricant comprises at least one of a mineral oil, an alkylbenzene oil, or a solid lubricant additive compound held in colloidal suspension.

15. The method of claim 14 wherein the HFC refrigerant comprises R-245fa refrigerant.

16. A lubricating mixture for use with a fluid displacement machine, the mixture comprising:
A. a fluid; and
B. at least one lubricant that is neither soluble nor miscible with the fluid, said lubricant combined with the fluid to form a colloidal mixture (i) suitable for lubricating a fluid displacement machine when the lubricant is dispersed within the mixture and (ii) wherein said lubricant does not remain dispersed in the mixture in the absence of agitation.

17. The mixture of claim 16 wherein the machine is a screw expander.

18. The mixture of claim 16 wherein the fluid comprises an HFC refrigerant and the lubricant comprises at least one of a mineral oil, an alkylbenzene oil, or a solid lubricant additive compound held in colloidal suspension.

19. The mixture of claim 18 wherein the HFC refrigerant comprises R-245fa refrigerant.

20. The mixture of claim 16 wherein the mixture flowing through the machine comprises between 1% and 3% lubricant by mass.
